(19) United States
(12) Patent Application Publication
(10) Pub. No.: US 2024/0414616 A1
(43) Pub. Date: Dec. 12, 2024

(54) COMMUNICATION METHOD AND NETWORK DEVICE

(71) Applicant: GUANGDONG OPPO MOBILE TELECOMMUNICATIONS CORP., LTD., Dongguan (CN)

(72) Inventor: Fei LU, Dongguan (CN)

(21) Appl. No.: 18/813,459

(22) Filed: Aug. 23, 2024

Related U.S. Application Data
(63) Continuation of application No. PCT/CN2022/090701, filed on Apr. 29, 2022.

(51) Int. Cl. H04W 36/14; H04W 36/00

(52) U.S. Cl. CPC H04W 36/1446; H04W 36/0058; H04W 36/0061

(57) ABSTRACT

A communication method is applicable to a source access network device. The method includes: receiving first information from a source core network device, wherein the first information is configured for the source access network device to determine whether to perform a handover process on a terminal device, and the first information is related to capability information of the terminal device, wherein the capability information of the terminal device indicates whether the terminal device supports a handover to a different stand-alone non-public network (SNPN).

### CROSS-REFERENCE TO RELATED APPLICATION

This application is a continuation application of International Application No. PCT/CN2022/090701, filed Apr. 29, 2022, the entire disclosure of which is incorporated herein by reference.

### TECHNICAL FIELD

The present disclosure relates to the field of communications technologies, and in particular, relates to a communication method, a network device, a terminal device, a computer-readable storage medium, a computer program product, and a computer program.

### BACKGROUND

In some communication scenarios, management is conducted more effectively and securely using a non-public network (NPN). Stand-alone NPN (SNPN) is one type of NPN. The SNPN does not rely on functions provided by a public network of a network operator and is an NPN network isolated from a public land mobile network (PLMN). However, how to ensure the service continuity of a terminal device in an SNPN handover process is a problem to be solved.

### SUMMARY

Embodiments of the present disclosure provide a communication method, a source access network device, and a source core network device.

Some embodiments of the present disclosure provide a communication method, which is applicable to a source access network device. The method includes:
receiving first information from a source core network device; wherein
the first information is configured for the source access network device to determine whether to perform a handover process on a terminal device, and the first information is related to capability information of the terminal device indicating whether the terminal device supports a handover to a different SNPN.

Some embodiments of the present disclosure provide a source access network device. The source access network device includes: a processor and a memory configured to store at least one computer program, wherein the processor, when loading and running the at least one computer program stored in the memory, is caused to perform:
receiving first information from a source core network device, wherein the first information is configured for the source access network device to determine whether to perform a handover process on a terminal device, and the first information is related to capability information of the terminal device, wherein the capability information of the terminal device indicates whether the terminal device supports a handover to a different stand-alone non-public network (SNPN).

Some embodiments of the present disclosure provide a source core network device. The source core network device includes: a processor and a memory configured to store at least one computer program, wherein the processor, when loading and running the at least one computer program stored in the memory, is caused to perform:
receiving third information from a terminal device, wherein the third information contains capability information of the terminal device, the capability information of the terminal device indicating whether the terminal device supports a handover to a different stand-alone non-public network (SNPN); and
transmitting first information to the source access network device, wherein the first information is configured for the source access network device to determine whether to perform a handover process on the terminal device, the first information being related to the capability information of the terminal device.

### BRIEF DESCRIPTION OF DRA WINGS

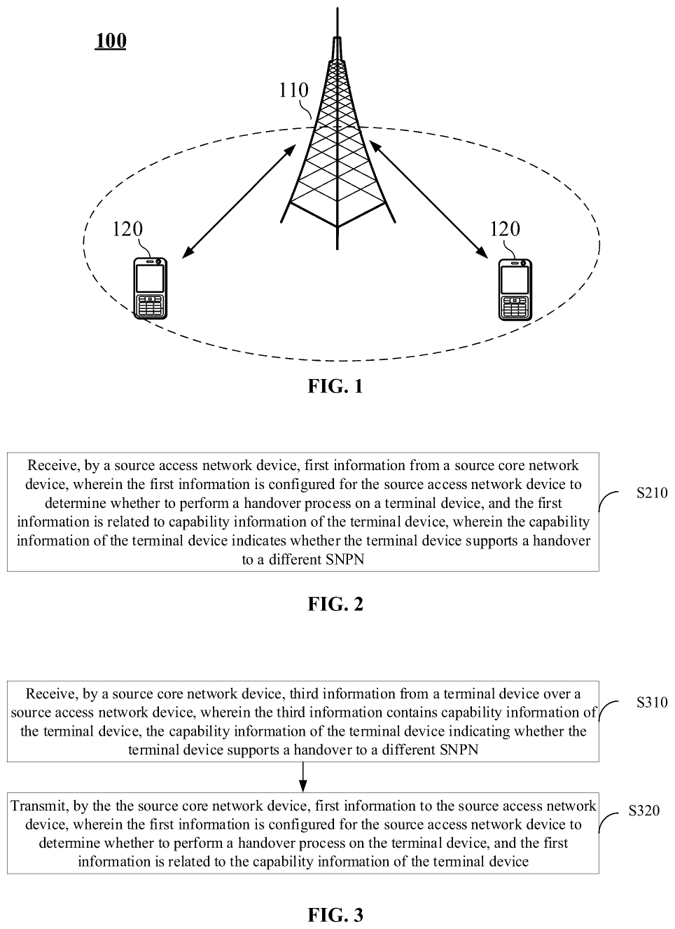

FIG. 1 is a schematic diagram of an application scenario according to some embodiments of the present disclosure.

FIG. 2 is a first schematic flowchart of a communication method according to some embodiments of the present disclosure.

FIG. 3 is a second schematic flowchart of a communication method according to some embodiments of the present disclosure.

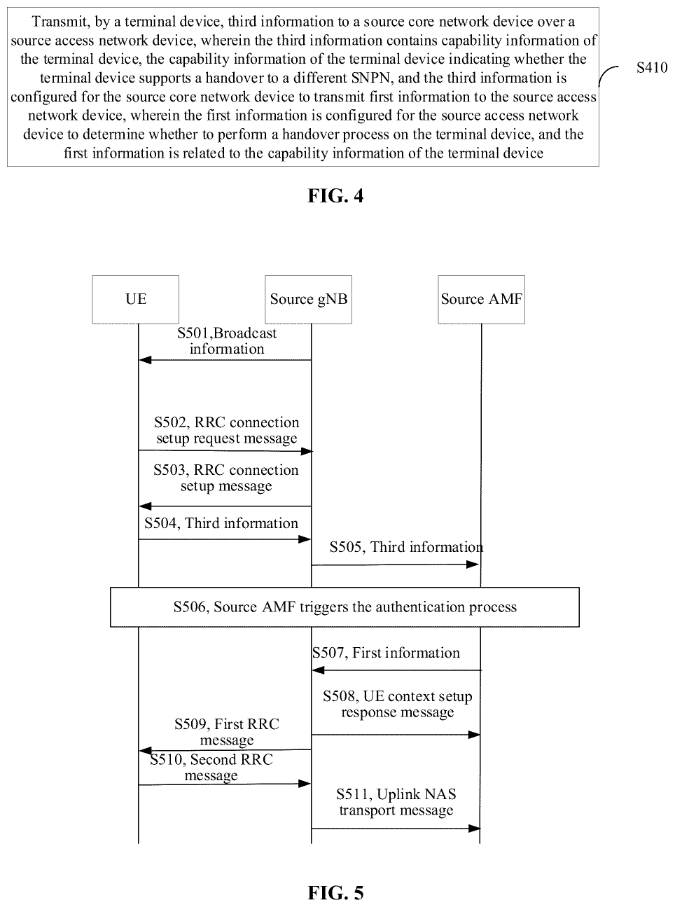

FIG. 4 is a third schematic flowchart of a communication method according to some embodiments of the present disclosure.

FIGS. 5 to 8 are flowcharts of various examples of communication methods according some embodiments of the present disclosure.

FIG. 9 is a first schematic block diagram of a source access network device according to some embodiments of the present disclosure.

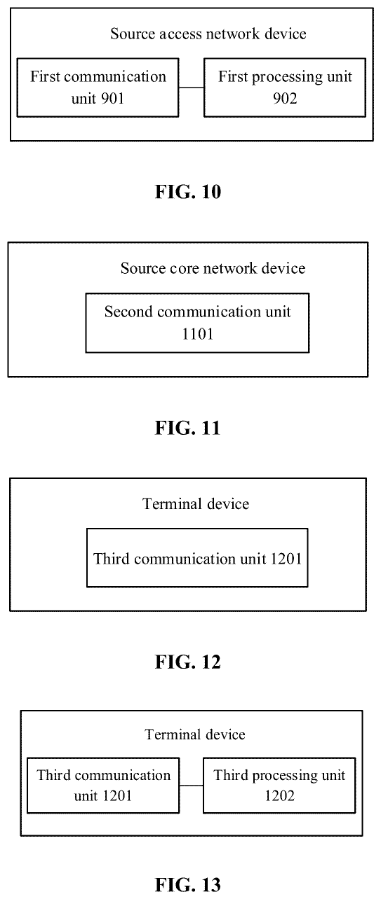

FIG. 10 is a second schematic block diagram of a source access network device according to some embodiments of the present disclosure.

FIG. 11 is a schematic block diagram of a source core network device according to some embodiments of the present disclosure.

FIG. 12 is a first schematic block diagram of a terminal device according to some embodiments of the present disclosure.

FIG. 13 is a second schematic block diagram of a terminal device according to some embodiments of the present disclosure.

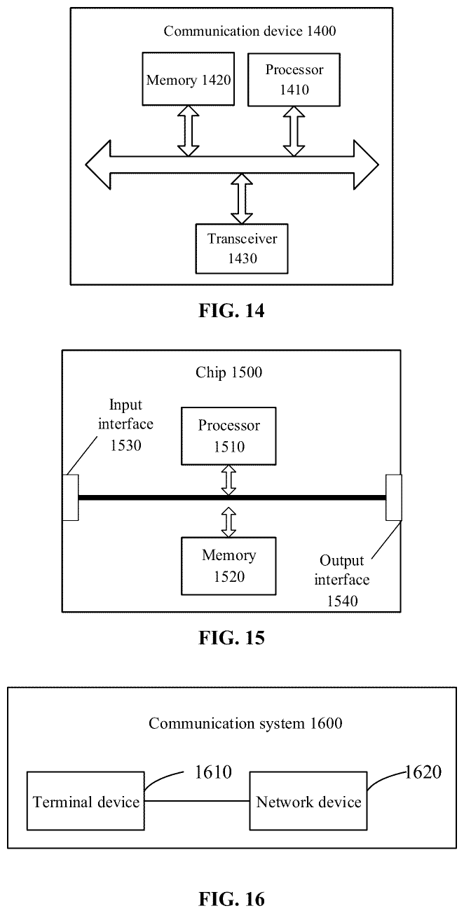

FIG. 14 is a schematic block diagram of a communication device according to some embodiments of the present disclosure.

FIG. 15 is a schematic block diagram of a chip according to some embodiments of the present disclosure.

FIG. 16 is a schematic block diagram of a communication system according to some embodiments of the present disclosure.

### DETAILED DESCRIPTION

The technical solutions according to the embodiments of the present disclosure are described hereinafter in conjunction with the accompanying drawings according to the embodiments of the present disclosure.

The technical solutions of the embodiments of the disclosure are applied to various communication systems, such as a global system of mobile communication (GSM) system, a code division multiple access (CDMA) system, a wideband code division multiple access (WCDMA) system, a general packet radio service (GPRS), a long-term Evolution (LTE) system, an advanced long-term evolution (LTE-A) system, a new radio (NR) system, an NR evolution system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), a wireless fidelity (Wi-Fi) system, a 5th Generation (5G) system, or other communication systems.

Typically, traditional communication systems support a limited number of connections and are easy to implement. However, with development of communication technologies, mobile communication systems will support not only conventional communications, but also, for example, device-to-device (D2D) communications, machine-to-machine (M2M) communications, machine type communications (MTCs), vehicle-to-vehicle (V2V) communications, or vehicle-to-everything (V2X) communications. The embodiments of the present disclosure are also applicable to these communication systems.

In some embodiments, the communication systems in the embodiments of the present disclosure are applicable to a carrier aggregation (CA) scenario, a dual connectivity (DC) scenario, or a standalone (SA) networking scenario.

In some embodiments, the communication system according to the embodiments of the present disclosure is applicable to an unlicensed spectrum, wherein the unlicensed spectrum is considered as a shared spectrum; or the communication system according to the embodiments of the present disclosure is applicable to a licensed spectrum, wherein the licensed spectrum is considered as an unshared spectrum.

Some embodiments of the present disclosure are described in conjunction with a network device and a terminal device, wherein the terminal device may also be referred to as a user equipment (UE), an access terminal, a subscriber unit, a subscriber station, a mobile terminal, a mobile station, a remote station, a remote terminal, a mobile device, a user terminal, a terminal, a wireless communication device, a user agent, or a user device.

The terminal device is a station (ST) in a WLAN, or a cellular phone, a cordless phone, a Session Initiation Protocol (SIP) phone, a wireless local loop (WLL) station, a personal digital assistant (PDA) device, a handheld device with a wireless communication function, a computing device, or another processing device connected to a wireless modem, an in-vehicle device, a wearable device, a terminal device in a next generation communication system, such as an NR network, or a terminal device in an evolved public land mobile network (PLMN), or the like.

In some embodiments of the present disclosure, the terminal device is deployed on the land, for example, indoors or outdoors, handheld, wearable, or in vehicles; or deployed on water (for example, on a ship); or the terminal device is deployed in air (for example, on an airplane, a balloon, or a satellite).

In some embodiments of the present disclosure, the terminal device is a mobile phone, a pad, a computer with a wireless transceiver function, a virtual reality (VR) terminal device, an augmented reality (AR) terminal, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, or the like.

By way of example but not limitation, in the embodiments of the present disclosure, the terminal device is a wearable device. The wearable device is also referred to as a wearable smart device, which is a generic term for wearable devices, such as glasses, gloves, watches, clothing, and shoes, which are intelligently designed and developed for daily wear by using wearable technologies. The wearable device is a portable device that is directly worn on the body or integrated into the clothing or accessories of the user. The wearable device is not only a hardware device, but also achieves powerful functions through software support as well as data interaction and cloud interaction. The wearable smart device in a broad sense includes devices such as smart watches or smart glasses that have full functionality and large size, and are capable of implementing all or part of functionality without depending on the smart phone, and devices such as various types of smart bracelets and smart jewelries for monitoring physical signs, which are dedicated to a specific type of application functions and need to be used in cooperation with other devices such as the smart phone.

In some embodiments of the present disclosure, the network device is a device for communication with a mobile device, and the network device is an access point (AP) in a WLAN, a base transceiver station (BTS) in a GSM or a CDMA, a NodeB (NB) in a WCDMA, or an evolutional Node B (eNB, or eNodeB) in the LTE network, a relay station, an access point, an in-vehicle device, a wearable device, a network device (gNB) in an NR network, a network device in a future evolved PLMN network, or a network device in an NTN network.

By way of example but not limitation, in the embodiments of the present disclosure, the network device has mobile characteristics. For example, the network device is a mobile device. In some embodiments, the network device is a satellite, or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. In some embodiments, the network device is a base station installed in locations such as land and water.

In some embodiments of the present disclosure, the network device provides services for cells, and the terminal device communicates with the network device over transmission resources (e.g., frequency domain resources or frequency spectrum resources) used by the cell, which is a cell corresponding to the network device (e.g., a base station). The cell is a base station corresponding to a macro base station or a small cell. The small cell herein includes a metro cell, a micro cell, a pico cell, or a femto cell. The small cells are characterized by a small coverage area and low transmission power, which are suitable for providing high-speed data transmission services.

FIG. 1 illustrates a communication system 100 as an example. The communication system includes a network device 110 and two terminal devices 120. In some embodiments, the communication system 100 includes a plurality of network devices 110, and a coverage area of each of the network devices 110 includes other numbers of terminal devices 120, which are not limited in the embodiments of the present disclosure.

In some embodiments, the communication system 100 further includes other network entities such as a mobility management entity (MME) and an access and mobility management function (AMF), which is not limited in the embodiments of the disclosure.

The network devices further include an access network device and a core network device. That is, the wireless communication system further includes a plurality of core networks for communicating with the access network device. The access network device is an evolutional Node B (cNB or e-NodeB), a macro Node B, a micro Node B (also known as “small node B”), a micro-micro Node B, an AP, a transmission point (TP), or a next-generation Node B (gNodeB) in an LTE system, an NR system, or an authorized auxiliary access long-term evolution (LAA-LTE) system.

It is understandable that a device having communication functions in networks/systems according to the embodiments of the present disclosure is referred to as a communication device. Taking the communication system shown in FIG. 1 as an example, the communication devices include a network device and a terminal device having a communication function, wherein the network device and the terminal device are specific devices according to the embodiments of the present disclosure, which are not repeated herein. The communication device further includes other devices in the communication system, such as a network controller or a mobile management entity, which are not limited in the embodiments of the present disclosure.

For case of understanding of the embodiments of the present disclosure, the basic processes and basic concepts involved in the embodiments of the present disclosure are briefly described hereinafter. It should be understood that the basic processes and the basic concepts described hereinafter do not limit the embodiments of the present disclosure.

It should be understood that the terms “system” and “network” are often used interchangeably herein. The term “and/or” herein is merely a way to describe an association relationship between associated objects, indicating that there are three possible relationships. For example, the phrase “A and/or B” means (A), (B), or (A and B). In addition, the symbol “/” herein generally indicates an “or” relationship between the associated objects.

It should be understood that the term “indicate” in the embodiments of the present disclosure is a direct indication, an indirect indication, or an indication that there is an associated relationship. For example, the phrase “A indicating B” means that A indicates B directly, e.g., B is acquired by A; or that A indicates B indirectly, e.g., A indicates C by which B may be acquired; or that an association is present between A and B.

In the description of the embodiments of the present disclosure, the term “correspond” may indicate a direct or an indirect correspondence relationship between two objects, an association relationship between two objects, a relationship of indicating and being indicated, configuring and being configured, or the like.

For ease of understanding of the technical solutions according to the embodiments of the present disclosure, the relevant technologies of the embodiments of the present disclosure are described hereinafter, and the following relevant technologies may be combined with the technical solutions of the embodiments of the present disclosure in any combination as an optional option, and all of them shall fall within the protection scope of the embodiments of the present disclosure.

FIG. 2 is a first schematic flowchart of a communication method according to some embodiments of the present disclosure. The method is applicable to the system shown in FIG. 1, but is not limited thereto. The method includes at least some of the following content.

In S210, a source access network device receives first information from a source core network device, wherein the first information is configured to determine whether to perform a handover process on a terminal device, and the first information is related to capability information of the terminal device, wherein the capability information of the terminal device indicates whether the terminal device supports a handover to a different SNPN.

In some embodiments, the access network device is a radio access network (RAN) device, and the source access network device is referred to a source RAN device. Furthermore, the source access network device is referred to a source RAN device in a source SNPN. For example, the source RAN device is a source base station, a source gNB, or a source eNB. For example, the source SNPN is a SNPN where the terminal device is currently located.

In some embodiments, the source core network device is in a network where the source access network device is located. For example, the source core network device is a source AMF entity of a source SNPN.

The capability information of the terminal device indicates whether the terminal device supports the handover to the different SNPN. In some embodiments, the capability information of the terminal device indicates whether the terminal device supports a handover from the source SNPN to a target SNPN, wherein the target SNPN is different from the source SNPN. For example, the target SNPN being different from the source SNPN means that an identifier of the target SNPN is different from an identifier of the source SNPN.

In some embodiments, prior to performing S210, the method further includes: transmitting, by the source access network device, third information from the terminal device to the source core network device, wherein the third information contains the capability information of the terminal device.

In some embodiments, in addition to the capability information of the terminal device, the third information further contains at least one of an identifier of the terminal device, a security capability of the terminal device, a requested network slice selection assistance information (NSSAI), or the last registered tracking area indicator (TAI). The identifier of the terminal device is referred to as a UE ID, and includes 5G globally unique temporary identity (5G-GUTI) or a subscription concealed identifier (SUCI). In the case that the terminal device is not provided with the 5G-GUTI, the SUCI is taken as the identifier of the terminal device. In the case that the terminal device is provided with the 5G-GUTI, the 5G-GUTI is taken as the identifier of the terminal device, that is, the SUCI is not taken as the identifier of the terminal device.

It should be noted that upon receiving the third information (for example, an NAS message container) from the terminal device, the source access network device transparently transmits the third information to the source core network device without parsing the third information.

For example, in the case that the source access network device receives the third information from the terminal device, the third information is carried by a radio resource control (RRC) connection setup complete message. In the case that the source access network device transmits the third information to the source core network device, the third information is carried by an initial UE message.

In the case that the third information is carried by the RRC connection setup complete message, the third information is carried by the NAS container in the RRC connection setup complete message. For example, the third information is a non-access stratum (NAS) message registration request message in the NAS container.

In some embodiments, in addition to the third information, the RRC connection setup complete message further carries an identifier of a first SNPN, wherein the identifier of the first SNPN is an ID of the first SNPN, and the first SNPN is a SNPN selected by the terminal device. For example, the first SNPN is the SNPN selected by the terminal device when accessing the source access network device, that is, a source SNPN where the terminal device is currently located.

In some embodiments, in the case that the third information is carried by the initial UE message, the third information is carried by a NAS container in the initial UE message. In addition to the third information (that is, the NAS container), the initial UE message further carries at least one of an RRC establishment reason value, location information of the terminal device, or the identifier of the first SNPN. The location information of the terminal device, that is, user location information (UCL), is composed of: a PLMN ID, a cell ID, a tracking area code (TAC). That is, ULI=PLMN ID+ cell id+TAC.

In some embodiments, transmitting the third information from the terminal device to the source core network device, includes: upon receiving the RRC connection setup complete message carrying the third information, determining, based on the identifier of the first SNPN contained in the RRC connection setup complete message, a core network device corresponding to the first SNPN as the source core network device; transmitting the initial UE message carrying the third information to the source core network device.

In a case where the above processing is completed, the S210 is performed, that is, the source access network device receives the first information from the source core network device.

In some embodiments, the first information is carried by a UE context setup request message. Furthermore, in addition to the first information, the UE context setup request message further includes at least one of a NAS container registration accept message, a security parameter, an allowed NSSAI, or a 5G-S-TMSI. The registration accept message carries at least one of the allowed NSSAI, a TAI list, a new 5G-GUTI, or the like.

In addition, upon receiving the first information from the source core network device, the source access network device further transmits the UE context setup response message to the source core network device.

In some embodiments, the first information contains at least one of the capability information of the terminal device or an SNPN list.

For example, the SNPN list contains an identifier of a second SNPN, wherein the second SNPN is equivalent to the first SNPN, wherein the first SNPN is selected by the terminal device, and the identifier of the second SNPN is different from the identifier of the first SNPN. The number of the second SNPN is one or more, which is not limited in the embodiments of the present disclosure. The first SNPN is selected by the terminal device. For example, the first SNPN is selected by the terminal device for accessing the source access network device this time, that is, the source SNPN where the terminal device is currently located.

In some embodiments, the first information contains the capability information of the terminal device and the SNPN list. In this case, whether the capability information of the terminal device indicates that the terminal device supports the handover to the different SNPN or not, the first information contains the capability information of the terminal device and the SNPN list. In some embodiments, the first information contains the SNPN list. For example, in the case that the capability information of the terminal device indicates that the terminal device supports the handover to the different SNPN, the first information contains the SNPN list. In this case, the first information contains the SNPN list and does not contain the capability information of the terminal device. In the case that the capability information of the terminal device indicates that the terminal device does not support the handover to the different SNPN, the first information does not contain the SNPN list or the capability information of the terminal device.

In this case, whether the SNPN list is contained in the first information is determined by the source core network device based on whether the capability information of the terminal device indicates that the terminal device supports the handover to the different SNPN or not. In this case, the first information does not need to contain the capability information of the terminal device. If the source access network device acquires the SNPN list from the first information, the source access network device indirectly determines that the terminal device supports the handover to the different SNPN. If the source access network device does not acquire the SNPN list from the first information, the source access network device determines that the terminal device does not support the handover to the different SNPN.

Upon receiving the first information, the source access network device further performs: transmitting the UE context setup response message to the source core network device; transmitting a first RRC message to the terminal device, wherein the first RRC message carries the NAS container registration accept message; receiving a second RRC message carrying a registration complete message from the terminal device, wherein the registration complete message is configured to confirm that the new 5G-GUTI takes effect; transmitting an uplink NAS transport message to the source core network device.

In some embodiments, upon completing the processing described above, the method further includes: performing, by the source access network device, a processing on the terminal device based on the first information. For example, the source access network device receives a measurement report of the terminal device from the terminal device and performs the processing on the terminal device based on the first information. Based on different contents contained in the first information (i.e., different capabilities of the terminal device), the processing performed by the source access network device on the terminal device is also different, which is described hereinafter.

In some embodiments, the method further includes: performing, by the source access network device, a handover process on the terminal device based on the measurement report of the terminal device and the first information in response to, based on the first information, determining that a first condition is satisfied.

For example, the first condition includes one of the first information containing the SNPN list and not containing the capability information of the terminal device; or the first information containing the SNPN list and the capability information of the terminal device, and the capability information of the terminal device indicating that the terminal device supports the handover to the different SNPN.

In some embodiments, determining whether the first condition is satisfied based on the first information, includes: determining whether the first information contains the SNPN list and the capability information of the terminal device; determining that the first condition is satisfied in response to determining that the first information contains the SNPN list and does not contain the capability information of the terminal device.

In response to determining the first information contains the SNPN list and the capability information of the terminal device, whether the capability information of the terminal device indicates that the terminal device supports the handover to the different SNPN is determined; and in response to determining that the capability information of the terminal device indicates that the terminal device supports the handover to the different SNPN, it is determined that the first condition is satisfied.

In some embodiments, in response to determining that the first information does not contain the SNPN list or the capability information of the terminal device, it is determined that the first condition is not satisfied. Alternatively, in response to determining that the first information contains the SNPN list and the capability information of the terminal device, if it is determined that the capability information of the terminal device indicates that the terminal device does not support the handover to the different SNPN, it is determined that the first condition is not satisfied.

In some embodiments, performing the handover process on the terminal device based on the measurement report of the terminal device and the first information, includes: determining a target access network device based on the measurement report of the terminal device and the SNPN list in the first information; determining a target SNPN where the target access network device is located, wherein the target SNPN is contained in the second SNPN of the SNPN list; and transmitting a first handover command to the terminal device, wherein the first handover command contains identifier-related information of the target SNPN and an identifier of the target access network device.

Herein, the method further includes: receiving the measurement report of the terminal device, wherein the timing of receiving the measurement report of the terminal device is prior to performing the process on the terminal device in the handover process based on the first information.

The measurement report of the terminal device includes identifiers of one or more candidate access network devices. In some embodiments, the measurement report of the terminal device further includes signal strengths of the one or more candidate access network devices. The signal strengths of the one or more candidate access network devices refer to signal reception strengths of the one or more candidate access network devices measured by the terminal device. The signal reception strength includes at least one of a reference signal receiving power (RSRP), a reference signal receiving quality (RSRQ), or the like.

In some embodiments, determining the target access network device based on the measurement report of the terminal device and the SNPN list in the first information, includes: determining the one or more candidate access network devices based on the measurement report of the terminal device; determining the target access network device from the one or more candidate access network device based on an identifier of an SNPN supported by the one or more candidate access network devices and the identifier of the second SNPN contained in the SNPN list in the first information.

In some embodiments, determining the one or more candidate access network devices based on the measurement report of the terminal device, includes: extracting the one or more candidate access network devices from the measurement report of the terminal device, and determining the identifier of the SNPN supported by the one or more candidate access network devices. Herein, extracting the one or more candidate access network devices includes: extracting identifiers of the one or more candidate access network devices; or extracting identifiers of the one or more candidate access network devices and the signal strengths of the one or more candidate access network devices.

In some embodiments, determining the target access network device from the one or more candidate access network devices based on the identifier of the SNPN supported by the one or more candidate access network devices and the identifier of the second SNPN contained in the SNPN list in the first information, includes: determining one or more filtered candidate access network devices from the one or more candidate access network devices based on the identifier of the second SNPN contained in the SNPN list in the first information and the identifier of the SNPN supported by the one or more candidate access network devices; and determining the target access network device from the one or more filtered candidate access network devices.

In some embodiments, determining the one or more filtered candidate access network devices from the one or more candidate access network devices based on the identifier of the second SNPN contained in the SNPN list in the first information and the identifier of the SNPN supported by the one or more candidate access network devices, includes: in the case that an identifier of the SNPN supported by an i^{th} candidate access network device in the one or more candidate access network devices is the same as any one of identifiers of second SNPNs in the SNPN list, determining the i^{th} candidate access network device as one of the one or more filtered candidate access network devices, wherein i is a positive integer.

For example, the SNPN list contains identifiers of three second SNPNs, namely an SNPN 1, an SNPN 2, and an SNPN 3. There are three candidate access network devices, namely, a candidate access network device 1, a candidate access network device 2, and a candidate access network device 3. An identifier of an SNPN supported by the candidate access network device 1 is the SNPN 1, an identifier of an SNPN supported by the candidate access network device 2 is the SNPN 3, and an identifier of an SNPN supported by the candidate access network device 3 is an SNPN 5. Then the identifier of the SNPN supported by the candidate access network device 1 and the identifier of the SNPN supported by the candidate access network device 2 are determined to be the same as the identifiers of the second SNPNs contained in the SNPN list, and the candidate access network device 1 and the candidate access network device 2 are determined as the filtered candidate access network devices.

In the case that the number of the one or more filtered candidate access network devices is one, the filtered candidate access network device is directly determined as the target access network device.

In some embodiments, in the case that the number of the one or more filtered candidate access network devices is a plurality, determining the target access network device from the one or more filtered candidate access network devices, includes at least one of:
selecting any one of a plurality of filtered candidate access network devices as the target access network device;
selecting a filtered candidate access network device with the greatest signal strength from a plurality of filtered candidate access network devices as the target access network device; or
selecting a filtered candidate access network device with the least payload from a plurality of filtered candidate access network devices as the target access network device.

The above-mentioned process of determining the target access network device from the filtered candidate access network devices includes any one of the above processing methods, or a combination of the above processing methods. For example, a plurality of filtered candidate access network devices with the greatest signal strength are selected from the filtered candidate access network devices, and a filtered candidate access network device with the least payload is select from the filtered candidate access network devices with the greatest signal strength as the target access network device. For another example, a plurality of filtered candidate access network devices with the least payload are selected from the filtered candidate access network devices, and any one of the filtered candidate access network devices with the least payload is selected as the target access network device. For another example, a plurality of filtered candidate access network devices with the greatest signal strength and the least payload are selected from the filtered candidate access network devices, and any one of the filtered candidate access network devices with the greatest signal strength and the least payload is selected as the target access network device. It is understandable that the above are only exemplary description. Other processing methods may also be combined and used in the actual process, as long as the target access network device is selected from the candidate access network devices based on the SNPN list, the processing methods are falling within the protection scope of the embodiments of the present disclosure. The processing methods are not exhausted herein.

The source access network device determines the target SNPN where the target access network device is located, which refers to taking an SNPN corresponding to the target access network device as the target SNPN. Because the target access network device is acquired from the one or more filtered candidate access network device having the same identifier as the second SNPN in the SNPN list, and the SNPN list contains one or more second SNPNs, the target SNPN is one of the one or more second SNPNs, that is, an identifier of the target SNPN is one of the identifiers of the one or more second SNPNs.

Identifier-related information of the target SNPN contains one of: a target network identifier (NID); or an identifier of a target PLMN and a target NID.

It should be noted that the SNPN ID is represented as an SNPN ID; an identifier of a PLMN is represented as a PLMN ID, wherein the SNPN ID is composed of the PLMN ID and the NID. For example, a composition format is PLMN ID+NPN ID.

Accordingly, the method further includes: in the case that the source access network device determines that the identifier of the first SNPN of the terminal device is the same as the identifier of PLMN in the identifier of the target SNPN, the identifier-related information of the target SNPN only contains the target NID in the identifier of the target SNPN; otherwise, the identifier-related information of the target SNPN contains the identifier of the target PLMN and the target NID (that is, the identifier of the target SNPN). The first SNPN is the source SNPN of the terminal device. For example, the source SNPN is the SNPN where the terminal device is currently located, that is, the SNPN where the source access network device is located.

In some embodiments, prior to transmitting the first handover command to the terminal device, the method further includes: transmitting, by the source access network device, a first handover required message to the source core network device, wherein the first handover required message carries the identifier of the target SNPN and the identifier of the target access network device; selecting, by the source core network device, a target core network device; transmitting, by the source core network device, a Namf (service-based interface exhibited by AMF)_Communication_CreateUEContext request to the target core network device; transmitting, by the target core network device, the first handover request to a target access network device; transmitting, by the target access network device, a first handover request acknowledgement to the target core network device; transmitting, by the target core network device, a Namf_Communication_CreateUEContext response to the source core network device; receiving, by the source access network device, the first handover command from the source core network device.

By adopting the above technical solutions, in the case that the capability information of the terminal device is that the terminal device supports the handover to the different SNPN, the source access network device determines a suitable target access network device and a target SNPN for the terminal device, and the problem of terminal device service continuity caused by the unified release operation of terminal device that supports the handover to the different SNPN is avoided. In addition, additional signaling for these terminal devices to access the network again is reduced, thereby saving an overhead of air interface signaling.

In some embodiments, the method further includes: determining, by the source access network device, the one or more candidate access network devices based on the measurement report of the terminal device in response to determining, based on the first information, that a second condition is satisfied; and determining, by the source access network device, whether to perform the handover process on the terminal device based on the one or more candidate access network devices.

Herein, the method further includes: receiving, by the source access network device, the measurement report of the terminal device, wherein the timing of receiving the measurement report of the terminal device is prior to performing the process on the terminal device in the handover process based on the first information. The measurement report of the terminal device includes the same contents as in the embodiments described above, which is not repeated herein.

The second condition includes the first information containing the SNPN list and the capability information of the terminal device, and the capability information of the terminal device indicates that the terminal device does not support the handover to the different SNPN.

These embodiments are also used in combination with the above first condition. For example, the source access network device determines whether the first information contains the SNPN list and the capability information of the terminal device; in the case that the SNPN list and the capability information of the terminal device are included, the source access network device determines whether the capability information of the terminal device indicates that the terminal device supports the handover to the different SNPN; in response to determining that the capability information of the terminal device indicating the terminal device supports the handover to the different SNPN, the source access network device determines that the first condition is satisfied, and performing the process when the first condition is satisfied, which is repeated herein; in response to determining that the capability information of the terminal device indicating that the terminal device does not support the handover to the different SNPN, the source access network determines that the second condition is satisfied.

In some embodiments, determining whether to perform the handover process on the terminal device based on the one or more candidate access network devices, includes: in the case that the one or more candidate access network devices include one or more candidate first-type access network devices, selecting the target access network device from the one or more candidate first-type access network devices, wherein the first-type access network device is an access network device of a non-shared network; and transmitting a second handover command to the terminal device, wherein the second handover command contains the identifier of the target access network device.

For example, in the case that the one or more candidate access network devices include the one or more candidate first-type access network devices, selecting the target access network device from the one or more candidate first-type access network devices includes: determining whether the one or more candidate access network devices include the one or more candidate first-type access network devices; and in response to determining that the one or more candidate access network devices include the one or more candidate first-type access network devices, selecting the target access network device from the one or more candidate first-type access network device.

The first-type access network device is the access network device of the non-shared network. Because the access network device of the non-shared network does not support a shared network, an identifier of an SNPN corresponding the access network device is a unique SNPN identifier. In this case, if the target access network device is selected from the one or more candidate first-type access network device, it can ensure that the terminal device acquires a unique target SNPN corresponding to the target access network device based on broadcast information from the target access network device, and can also ensure that in subsequent registration and other processing, the terminal device and the target core network device corresponding to the target access network device uses the identifier of the same target SNPN for processing. Therefore, even if the capability information of the terminal device indicates that the terminal device does not support the handover to the different SNPN, the access network device of the non-shared network is selected for the terminal device as the target access network device for this handover process.

The number of the candidate first-type access network devices is one or more, and in the case that the number of the candidate first-type access network devices is one, the candidate first-type access network device is directly determined as the target access network device.

In some embodiments, in the case that the number of the candidate first-type access network devices is a plurality, selecting the target access network device from the one or more candidate first-type access network devices includes at least one of:
selecting any one of a plurality of candidate first-type access network devices as the target access network device;
selecting a candidate first-type access network device with the greatest signal strength from a plurality of candidate first-type access network devices as the target access network device; or
selecting a candidate first-type access network device with a least payload from a plurality of candidate first-type access network devices as the target access network device.

The aforementioned process of determining the target access network device from the candidate first-type access network devices includes any one of the above processes, or a combination of the above processes. For example, a plurality of candidate first-type access network devices with the greatest signal strength are selected from the candidate first-type access network devices, and a candidate first-type access network device with the least payload is selected from the candidate first-type access network devices with the greatest signal strength as the target access network device. For another example, a plurality of candidate first-type access network devices with the least payload are selected from the candidate first-type access network devices, and any one of the candidate first-type access network devices with the least payload is selected as the target access network device. For another example, a plurality of candidate first-type access network devices with the greatest signal strength and the least payload are selected from the candidate first-type access network devices, and any one of the candidate first-type access network devices with the greatest signal strength and the least payload is selected as the target access network device.

In some embodiments, prior to transmitting the second handover command to the terminal device, the method further includes: transmitting, by the source access network device, a second handover required message (which carries the identifier of the target access network device) to the source core network device; selecting, by the source core network device, a target core network device; the transmitting, by source core network device, a Namf_Communication_CreateUEContext request to the target core network device; transmitting, by the target core network device, the second handover request to a target access network device; transmitting, by the target access network device, a second handover request acknowledgement to the target core network device; transmitting, by the target core network device, a Namf_Communication_CreateUEContext response to the source core network device; receiving, by the source access network device, the second handover command from the source core network device.

By adopting the above technical solutions, in the case that the capacity information of the terminal device indicates that the terminal device does not support the handover to the different SNPN, if the measurement report of the terminal device includes the access network device of the non-shared network, the source access network device determines a suitable access network device of the non-shared network for the terminal device as the target access network device, and the problem of discontinuous service of the terminal device caused by the unified release operation of the terminal device that supports the handover to the different SNPN is avoided. Additional signaling for these terminal devices to access the network again is reduced, thereby saving the overhead of air interface signaling.

In some embodiments, the method further includes: determining, by the source access network device, the one or more candidate access network devices based on the measurement report of the terminal device in response to determining that the first information does not contain the SNPN list or the capability information of the terminal device; and selecting a candidate access network device corresponding to the first SNPN from the one or more candidate access network device as the target access network device. According to the description mentioned above, the first SNPN is the SNPN selected when accessing the source access network device this time, that is, the first SNPN is the source SNPN where the terminal device is currently located. That is, in response to determining that the first information does not contain the SNPN list or the capacity information of the terminal device, the source access network device determines that the terminal device does not support the handover to the different SNPN. Therefore, the source access network device selects the candidate access network device in the first SNPN as the target access network device. The method for selecting the candidate access network device is similar to the above processes, which is not repeated herein.

In some embodiments, in the case that the second condition is determined to be satisfied based on the first information, the one or more candidate access network devices are acquired from the measurement report of the terminal device; whether the one or more candidate access network devices include the candidate first-type access network device is determined; in the case that the one or more candidate access network devices include the candidate first-type access network device, the aforementioned processes are performed to acquire the second handover command, and the second handover command is transmitted; and in the case that the one or more candidate access network devices do not include the candidate first-type access network device, a connection between the terminal device and the source access network device is released. The method for releasing the connection between the terminal device and the source access network device includes a first method and a second method.

In the first method, determining whether to perform the handover process on the terminal device based on the one or more candidate access network devices, includes: releasing an RRC connection between the source access network device and the terminal device in the case that the one or more candidate access network devices do not include the candidate first-type access network device. That is, in the case that the one or more candidate access network devices do not include the candidate first-type access network device, that is, the one or more candidate access network devices only include the candidate second-type access network device, the source access network device directly releases the RRC connection to the terminal device. Then the terminal device re-performs an initial access process and access to the target access network device, which are not limited in the present disclosure.

In the second method, determining whether to perform the handover process on the terminal device based on the one or more candidate access network devices, includes: transmitting second information to the source core network device in the case that the one or more candidate access network devices do not include the candidate first-type access network device, wherein the second information is configured for the source core network device to release an NAS connection to the terminal device. That is, in the case that the one or more candidate access network devices do not include the candidate first-type access network device, that is, the one or more candidate access network devices only include the candidate second-type access network device, the source access network device does not select the target access network device for the terminal device, but notifies the source core network device to release the NAS connection to the terminal device by transmitting the second information to the source core network device.

In the first method and the second method, the second-type access network device is an access network device of the shared network. In the case that the one or more candidate access network devices do not include the candidate first-type access network device, that is, the one or more candidate access network devices only include the candidate second-type access network device, the source access network device controls itself or notifies the source core network device to release the connection to the terminal device. This is because the second-type access network device supports the shared network and corresponds identifiers of two or more SNPNs, that is, the second-type access network device does not correspond to a unique SNPN identifier. If the target access network device is selected from the candidate second-type access network device, it is impossible to ensure that the target SNPN acquired by the terminal device is the same as the identifier of the SNPN determined on the network side, which leads to the failure of subsequent authentication process because the terminal device and the network side use different SNPN service network names. Therefore, in the case that the capability information of the terminal device indicates that the terminal device does not support the handover to the different SNPN, and there is no first-type access network device around the source access network device (that is, only second-type access network device is around the source access network device), the connection to the terminal device is released directly, and the terminal device further selects the target SNPN by receiving broadcast information from other access network devices (compared with the terminal device, the terminal device receives the target access network device determined by itself), thereby ensuring the connection success rate of the terminal device.

Evidently, by adopting the above technical solutions, the source access network device receives the first information related to whether the terminal device supports the handover to the different SNPN, wherein the first information is configured for the source access network device to determine whether to perform the handover process on the terminal device. In this way, the source access network device determines whether to perform the handover process on the terminal device based on whether the terminal device supports the handover to the different SNPN, thereby avoiding the problem that the service continuity of the terminal device cannot be guaranteed because the network side performs the handover process that does not match the capability of the terminal device.

FIG. 3 is a second schematic flowchart of a communication method according to some embodiments of the present disclosure. The method is applicable to the system shown in FIG. 1, but is not limited thereto. The method includes at least some of the following contents.

In S310, a source core network device receives third information from a terminal device over a source access network device, wherein the third information contains capability information of the terminal device, the capability information of the terminal device indicating whether the terminal device supports a handover to a different SNPN.

In S320, the source core network device transmits first information to the source access network device, wherein the first information is configured for the source access network device to determine whether to perform a handover process on the terminal device, and the first information is related to the capability information of the terminal device.

In these embodiments, descriptions of the source access network device and the source core network device are the same as the aforementioned embodiments and not be repeated herein.

In S310, the source core network device receives the third information from the terminal device over the source access network device, which includes: upon receiving the third information from the terminal device, the source access network device transparently transmits the third information to the source core network device. In some embodiments, the third information is a registration request message.

In the case that the source core network device receives the third information from the source access network device, the third information is carried by the initial UE message. The contents of the third information and the initial UE information are the same as the contents described above and not be repeated herein.

In a case where the source core network device receives the third information, both the terminal device and the source core network device determine the identifier of the first SNPN as the serving network name. The terminal device and the source core network device acquire their own security parameters by using the serving network name, and perform the authentication process based on their own security parameters. The specific process of authentication process is not limited in the present disclosure.

Upon completing the authentication process, the source core network device performs the S320. The source core network device transmits the first information to the source access network device. This first information is carried by the UE context setup request message. The content of the first information is the same as the content described above and not repeated herein.

In some embodiments, in the case that the source core network device receives the third information, the third information is carried by the initial UE message. In some embodiments, in addition to the third information, the initial UE message further carries the identifier of the first SNPN. Accordingly, the source core network device acquires the capability information of the terminal device by parsing the third information from the initial UE message, and acquires the identifier of the first SNPN (that is, the SNPN selected by the terminal device) by parsing the initial UE message; the source core network device determines the SNPN equivalent to the first SNPN as the second SNPN, and generate the SNPN list based on the identifier of the second SNPN; and the source core network device generates the first information based on the capability information of the terminal device and the SNPN list, and transmits the first information to the source access network device. Accordingly, the source access network device acquires the SNPN list and the capability information of the terminal device by parsing the first information. The SNPN equivalent to the first SNPN is determined by the source core network device based on a pre-stored SNPN equivalence relationship, wherein the SNPN equivalence relationship includes a relationship between an identifier of an SNPN and identifiers of other SNPNs equivalent to the SNPN. It is understandable that there may be other determining methods, which are not exhausted herein.

In some embodiments, the source core network device determines whether the first information containing the SNPN list based on whether the capability information of the terminal device acquired by parsing supports the handover to the different SNPN. For example, the source core network device acquires the capability information of the terminal device by parsing the third information from the initial UE message, and acquires the identifier of the first SNPN by parsing the initial UE message; in response to determining that the terminal device does not support the handover to the different SNPN based on the capacity information of the terminal device, the source core network device determines that the first information does not contain the SNPN list or the capacity information of the terminal device; in response to determining that the terminal device supports the handover to the different SNPN based on the capability information of the terminal device, the source core network device determines the SNPN equivalent to the first SNPN as the second SNPN, and generates the SNPN list based on the identifier of the second SNPN; and the source core network device generates the first information based on the SNPN list, and transmits the first information to the source access network device.

In some embodiments, upon completing the above process, the method further includes: receiving, by the source core network device, second information from the source access network device, wherein the second information is configured for the source core network device to release the NAS connection to the terminal device. That is, upon transmitting the first information, in response to receiving the second information from the source access network device, the source core network device releases the NAS connection to the terminal device based on the second information.

By adopting the above technical solutions, the source core network device transmits the first information to the source access network device, wherein the first information is related to whether the terminal device has the capability of supporting the handover to the different SNPN, and the first information enables the source access network device to determine whether to perform the handover process on the terminal device. In this way, the source access network device determines whether to perform the handover process on the terminal device based on whether the terminal device supports the handover to the different SNPN, thereby avoiding the problem that the service continuity of the terminal device cannot be guaranteed because the network side performs the handover process that does not match the capability of the terminal device.

FIG. 4 is a third schematic flowchart of a communication method according to some embodiments of the present disclosure. The method is applicable to the system shown in FIG. 1, but is not limited thereto. The method includes at least some of the following contents.

In S410, a terminal device transmits third information to a source core network device over a source access network device, wherein the third information contains capability information of the terminal device, the capability information of the terminal device indicating whether the terminal device supports a handover to a different SNPN, and the third information is configured for the source core network device to transmit first information to the source access network device, wherein the first information is configured for the source access network device to determine whether to perform a handover process on the terminal device, and the first information is related to the capability information of the terminal device.

In these embodiments, the descriptions of the access network device, the source access network device, and the source core network device are the same as the embodiments described above, which are not repeated herein.

In S410, transmitting the third information to the source core network device over the source access network device, includes: transparently transmitting the third information to the source core network device over the source access network device.

The third information has the same content as the embodiments described above, which is not repeated herein.

In some embodiments, in the case that the terminal device transmits the third information to the source access network device, the third information is carried by the RRC connection setup complete message. In addition to the third information, the RRC connection setup complete message further carries the ID of the first SNPN. The identifier of the first SNPN is the ID of the first SNPN.

The first SNPN is the SNPN selected by the terminal device, that is, the first SNPN is the SNPN selected by receiving the broadcast information from the source access network device when the terminal device accesses the source access network device this time, that is, the current source SNPN. For example, the source access network device transmits the broadcast information, wherein the broadcast information carries the identifier of the SNPN (i.e., SNPN ID) supported by the source access network device; in the case that the broadcast information contains an identifier of one SNPN supported by the source access network device, the terminal device directly determines the identifier of the SNPN as the identifier of the first SNPN (that is, the identifier of the selected SNPN, that is, the identifier of the source SNPN); in the case that the broadcast information contains the identifiers of a plurality of SNPNs supported by the source access network device, the terminal device selects one identifier from the identifiers of the SNPNs as the identifier of the first SNPN, that is, the terminal device determines the SNPN selected this time as the first SNPN.

In a case where the aforementioned processes are completed, processes performed subsequently by the terminal device are described hereinafter.

In some embodiments, the method further includes: receiving, by the terminal device, a first handover command from the source access network device, wherein the first handover command contains identifier-related information of the target SNPN and the identifier of the target access network device.

In some embodiments, prior to receiving the first handover command from the source access network device, the method further includes: transmitting, by the terminal device, a measurement report of the terminal device to the source access network device. The contents of the measurement report of the terminal device and the specific processing method of the source access network device have already been described in the embodiments described above, which are not repeated herein.

The identifier-related information of the target SNPN contains one of: a target NID, an identifier of the target PLMN, and a target NID.

In some embodiments, upon receiving the first handover command, the method further includes: in response to only extracting the target NID from the identifier-related information of the target SNPN in the first handover command, determining, by the terminal device, the identifier of the target PLMN and the target NID as the identifier of the target SNPN based on an identifier of a first PLMN in the first SNPN as the identifier of the target PLMN; in response to extracting the identifier of the target PLMN and the target NID from the identifier-related information of the target SNPN in the first handover command, determining, by the terminal device, the identifier of the target PLMN and the target NID as the identifier of the target SNPN. The first SNPN is the source SNPN of the terminal device, which is the SNPN where the terminal device is currently located, that is, the SNPN where the source access network device is located.

In some embodiments, the method further includes: receiving, by the terminal device, a second handover command from the source access network device, wherein the second handover command contains an identifier of a target access network device, the target access network device being a first-type access network device, the first-type access network device being an access network device of a non-shared network.

In some embodiments, prior to receiving the second handover command from the source access network device, the method further includes: transmitting, by the terminal device, a measurement report of the terminal device to the source access network device. The contents of the measurement report of the terminal device and the specific processing method of the source access network device have been described in the embodiments mentioned above, which are not repeated herein.

In these embodiments, the capability information of the terminal device is that the terminal device does not support the handover to the different SNPN. In this case, one or more candidate access network devices in the measurement report of the terminal device includes a candidate first-type access network device, that is, an access network device of the non-shared network. Because the access network device of the non-shared network does not support the shared network, an identifier of an SNPN corresponding to the access network device is a unique SNPN identifier. Therefore, in the case that the target access network device is selected from the candidate first-type access network device, it can ensure that the terminal device acquires the unique target SNPN corresponding to the target access network device over the broadcast information from the target access network device, such that it can ensure that both the terminal device and the target core network device corresponding to the target access network device use the identifier of the unique target SNPN as the serving network name for subsequent processes, such as a registration process and an authentication process.

In some embodiments, the capability information of the terminal device is that the terminal device does not support the handover to the different SNPN. In this case, the one or more candidate access network devices included in the measurement report of the terminal device do not include the candidate first-type access network device, that is, the one or more candidate access network devices only include the candidate second-type access network device, and the source access network device controls itself or notifies the source core network device to release the connection to the terminal device. The process that the source access network device controls the release of the connection to the terminal device is the same as the embodiments described above, which is not repeated herein.

Upon completing the processes described above, the terminal device further performs the following processes.

The terminal device receives fourth information from the target core network device over the target access network device, wherein the fourth information contains identifier-related information of a registered SNPN, the identifier-related information of the registered SNPN contains one of: a registered NID; or an identifier of a registered PLMN and a registered NID.

That is, the terminal device further receives the fourth information from the target access network device at the handover execution stage or in a case where the handover is completed. The fourth information carries the identifier-related information of the SNPN registered by the terminal device this time. The fourth information further contains a new 5G-GUTI allocated for the terminal device this time.

The fourth information is carried by different messages in different processing stages. For example, in the handover execution stage, the fourth information is carried by a registration accept message; and in the handover completion stage, the fourth information is carried by a UE configuration update command.

It should be noted that in the case that the aforementioned terminal device accesses the target access network device based on the first handover command, the identifier of the aforementioned registered SNPN is the same as the identifier of the target SNPN. In the case that the aforementioned terminal device accesses the target access network device based on the second handover command, the aforementioned registered SNPN is determined by the target core network device for the terminal device, and the registered SNPN is referred to as the target SNPN.

Upon receiving the fourth information, if the terminal device acquires the registered NID by parsing the fourth information, the terminal device determines the identifier of the PLMN of the first SNPN (i.e., the source SNPN) currently stored as the identifier of the registered PLMN, and acquire the identifier of the registered SNPN by combining the identifier of the registered PLMN with the NID. If the identifier of the registered PLMN and the registered NID are parsed from the fourth information, the combination of the registered PLMN identifier and the registered NID is used to acquire the identifier of the registered SNPN.

In some embodiments, the method further includes: transmitting, by the terminal device, fifth information to the target core network device over the target access network device, wherein the fifth information is configured for the target core network device to determine whether to perform an authentication process on the terminal device.

The fifth information contains a registered SNPN confirmation message, or does not contain the registered SNPN confirmation message. The registered SNPN confirmation message refers to a confirmation message of the identifier of the registered SNPN (that is, the registered SNPN ID).

In some embodiments, upon receiving the fourth information, the terminal device acquires the identifier of the registered SNPN, and the fifth information contains the registered SNPN confirmation message; in the case that the terminal device cannot acquire the identifier of the registered SNPN by parsing the fourth information upon receiving the fourth information, the fifth information does not contain the registered SNPN confirmation message. It is understandable that upon receiving the fourth information, the reason why the terminal device cannot acquire the identifier of the registered SNPN by parsing the fourth information is that the terminal device does not have the capability of supporting the handover to the different SNPN, and the terminal device generally cannot correctly identify the identifier of the registered SNPN in the registered reception message. Therefore, this type of terminal device does not carry the registered SNPN confirmation message in the fifth information.

In some embodiments, the fifth information contains the registered SNPN confirmation message, wherein the fifth information is configured for the target core network device to perform the authentication process on the terminal device based on the identifier of the registered SNPN. For example, the target core network device and the terminal device perform the authentication process by using the identifier of the registered SNPN as the service network name. The specific authentication process is not described herein.

In some embodiments, the fifth information does not contain the registered SNPN confirmation message, and the fifth information is configured for the target core network device to determine whether to release the NAS connection to the terminal device or to register the terminal device.

That is, in the case that the fifth information does not contain the registered SNPN confirmation message, the target core network device determines that the terminal device cannot parse the identifier of the registered SNPN. In this case, the target core network device directly releases the NAS connection to the terminal device or directly registers the terminal device.

Furthermore, the fifth information does not contain the registered SNPN confirmation message, and the fifth information is configured for the target core network device to determine to release the NAS connection to the terminal device or to register the terminal device in the case that the target access network device is not the first-type access network device.

That is, in the case that the fifth information does not contain the registered SNPN confirmation message, the target core network device determines that the terminal device cannot parse the identifier of the registered SNPN. In this case, the target core network device determines that whether the target access network device of the current terminal device is the first-type access network device. In the case that the target access network device is not the first-type access network device, the target core network device directly releases the NAS connection to the terminal device or directly registers the terminal device. In the case that the target access network device is the first-type access network device, the target core network device performs the authentication process on the terminal device by using the identifier of the registered SNPN. This is because in the case that the target access network device is the first-type access

network device, the terminal device acquires the unique target SNPN corresponding to the target access network device by receiving the broadcast information from the target access network device, such that in the process such as the registration process or the authentication process, the identifier of the target SNPN used by the terminal device is the same as the identifier of the registered SNPN used by the target core network device. Therefore, the terminal device and the target core network device adopt the same serving network name for the authentication process, thereby ensuring the continuity of subsequent services.

In the case that the target access network device is the second-type access network device (i.e., not the first-type access network device), the terminal device determines that the identifier of the target SNPN determined by receiving the broadcast information from the target access network device is not the identifier of the unique SNPN supported by the target access network device, such that in the process such as the registration process or the authentication process, the identifier of the target SNPN used by the terminal device and the identifier of the registered SNPN used by the target core network device may not be the same, and the continuity of subsequent services cannot be ensured. Therefore, the connection to the terminal device is released directly, which reduces the time consumed by waiting for the authentication process to complete, determining the authentication failure, and controlling the terminal device to reconnect to a new target access network device, and reduces the signaling overhead caused by the authentication process.

In some embodiments, the fifth information is carried by the registration completion message or the UE configuration update confirmation message. It should be noted that the fifth information is different in different processing flows or different processing stages.

For example, in the registration process at the handover execution stage, the fifth information is carried by the registration completion message. In the case that the fifth information is carried by the registration completion message, the registration completion message is further configured to confirm that a new 5G-GUTI is effective. Therefore, the fifth information contains two information units, or two information elements (IE), which are referred to as a first IE and a second IE respectively, wherein the first IE is configured to carry a confirmation message that the new 5G-GUTI takes effect, and the second IE is configured to carry the registered SNPN confirmation message.

In some embodiments, prior to transmitting the fifth information to the target core network device over the target access network device, the method further includes: transmitting, by the terminal device, a registration request message to the target core network device over the target access network device, wherein the registration request message includes: a 5G-GUTI, a UE security capability, a requested NSSAI; receiving, by the terminal device, the fourth information from the target core network device, that is, the fourth information is carried by the registration acceptance message, wherein the registration acceptance message carries a new 5G-GUTI and the identifier-related information of the registered SNPN.

In a case where the handover is completed, the fifth information is carried by the UE configuration update confirmation message. In the case that the fifth information is carried by the UE configuration update confirmation message, the UE configuration update confirmation message at least includes a third IE, wherein the third IE is configured to carry the registered SNPN confirmation message.

In some embodiments, prior to transmitting the fifth information to the target core network device over the target access network device, the method further includes: receiving, by the terminal device, the fourth information from the target core network device, that is, the fourth information is carried by a UE configuration update command, wherein the UE configuration update command carries the new 5G-GUTI and the identifier information of the registered SNPN.

By adopting the above technical solutions, the terminal device transmits the third information to the source core network device, wherein the third information carries the capability information indicating whether the terminal device supports the handover to the different SNPN. Based on the third information, the source access network device generates the first information related to the capability of the terminal device, wherein the first information enables the source access network device to determine whether to perform the handover process on the terminal device. In this way, the source access network device determines whether to perform the handover process on the terminal device based on whether the terminal device has the capability to support the handover to the different SNPN, thereby avoiding the problem that the service continuity of the terminal device cannot be ensured due to the network side's implementation of handover process that does not match the terminal device's capability.

Taking the source access network device being a source gNB, the source core network device being a source AMF, and the terminal device being a UE as an example, an illustration of the methods for communication provided by the above embodiments is illustrated in conjunction with FIG. 5.

In S501, the source gNB transmits the broadcast information, wherein the broadcast information carries the identifier of the SNPN supported by the source access network device.

For example, the broadcast information contains the SNPN ID (PLMN ID+NPN ID) supported by the source gNB.

In S502, the UE transmits the RRC connection setup request message to the source gNB, wherein the RRC connection setup request message carries an S-temporary mobile subscriber identity (S-TMSI), and an RRC establishment reason value.

Prior to performing the S502, the method further includes determining, by the UE, the identifier of the first SNPN. For example, in the case that the broadcast information contains an identifier of one SNPN supported by the source access network device, the terminal device directly determines the identifier of the SNPN as the identifier of the first SNPN (that is, the identifier of the selected SNPN); and in the case that the broadcast information contains the identifiers of a plurality of SNPNs supported by the source access network device, the terminal device selects one of the identifiers of the SNPNs as the identifier of the first SNPN (that is, the selected SNPN).

In S503, the source gNB returns the RRC connection setup message to the UE.

In S504, the UE transmits the third information to the source gNB.

The third information is carried by the RRC connection setup complete message. For example, the third information is carried by the NAS container in the RRC connection setup complete message. The third information is a NAS message-registration request message in the NAS container.

In some embodiments, in addition to the third information, the RRC connection setup complete message further carries the identifier of the first SNPN, wherein the identifier of the first SNPN is the ID of the first SNPN. The first SNPN is the SNPN selected by the terminal device. For example, the first SNPN is the SNPN selected by the terminal device when accessing the source access network device this time, that is, the source SNPN where the terminal device is currently located. In some embodiments, in addition to the capability information of the terminal device, the third information further contains at least one of: the identifier of the terminal device, the security capability of the terminal device, the requested NSSAI, or the last registered TAI. The identifier of terminal device is referred to as a UE ID, which includes the 5G-GUTI or the SUCI. In the case that the terminal device is not provided with the 5G-GUTI, the SUCI is taken as the identifier of the terminal device. In the case that the terminal device is provided with the 5G-GUTI, the 5G-GUTI is taken as the identifier of the terminal device, that is, the SUCI is not taken as the identifier of the terminal device.

In S505, the source gNB transmits the third information to the source AMF.

In some embodiments, in the case that the source access network device transmits the third information to the source core network device, the third information is carried by the initial UE message. For example, the third information is carried by the NAS container in the initial UE message. In addition to the third information (i.e., using the NAS container to carry the third information), the initial UE message further carries at least one of the RRC establishment reason value, information of the terminal device location, or the identifier of the first SNPN (i.e., selected SNPN ID). The information of the terminal device location, that is, the ULI, ULI=PLMN ID+ cell id+TAC.

In S506, the source AMF triggers the authentication process.

In the authentication process, the service network names used by the UE and the network side are the selected SNPN ID, i.e., the identifier of the first SNPN. The specific process of the authentication process is not limited herein. In a case where the authentication processing is passed, the S507 is performed. Otherwise, the processing is ended.

It should be noted that in the authentication process triggered by the source AMF, there are also interactions with other devices of the core network, such as interactions with devices having an authentication server function (AUSF) or unified data management (UDM), which are not shown in FIG. 5 and not described in the embodiments of the present disclosure.

In S507, the source AMF transmits the first information to the source gNB.

In some embodiments, the first information contains the capability information of the terminal device and the SNPN list. In some other embodiments, in the case that the capability information of the terminal device indicates that the terminal device supports the handover to the different SNPN, the first information contains the SNPN list; and/or, in the case that the capability information of the terminal device indicates that the terminal device does not support the handover to the different SNPN, the first information does not contain the SNPN list. The SNPN list contains the identifier of the second SNPN, wherein the second SNPN is the SNPN equivalent to the first SNPN, the first SNPN being the SNPN selected by the terminal device, and the identifier of the second SNPN being different from the identifier of the first SNPN. The number of the second SNPN is one or more.

The first information is carried by the UE context setup request message. In addition to the first information, the UE context setup request message further includes at least one of: an NAS container-registration accept message, a security parameter, an allowed NSSAI, or a 5G-S-TMSI. The NAS container-registration accept message carries at least one of: the allowed NSSAI, a TAI list, a new 5G-GUTI, or the like.

In S508, the source gNB returns the UE context setup response message to the source AMF.

In S509, the source gNB transmits a first RRC message to the UE.

The first RRC message is configured to transmit the NAS container (for example, the NAS container-registration accept message) in process S507 to the UE.

In S510, the UE transmits a second RRC message to the source gNB.

The second RRC message in this process is configured to transmit the NAS container, wherein the NAS container contains a registration complete message. The registration complete message is configured to confirm that the new 5G-GUTI in S507 takes effect. The content contained in the NAS container is the same as the NAS container-registration accept message in S507.

In S511, the source gNB transmits an uplink NAS transport message to the source AMF. The NAS container in S510 is carried in the uplink NAS transport message. The specific content of the NAS container is the same as the above, and not repeated herein.

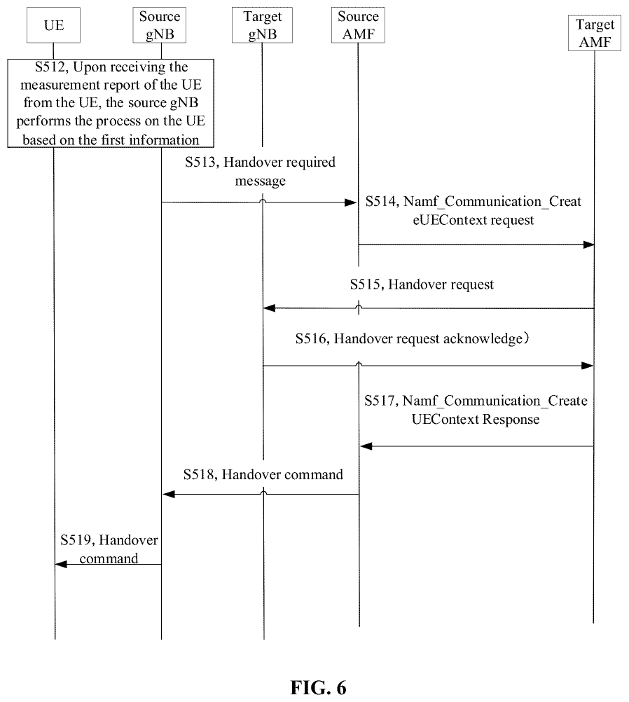

Taking the source access network device being the source gNB, the source core network device being the source AMF, a candidate access network device being a candidate gNB, the target access network device being the target gNB, the target core network device being the target AMF, and the terminal device being the UE as an example, an illustration of the methods for communication provided by the above embodiments is illustrated in conjunction with FIG. 6 on the basis of the above FIG. 5.

In S512, upon receiving the measurement report of the UE from the UE, the source gNB performs the process on the UE based on the first information.

In some embodiments, performing the process on the UE based on the first information includes: in response to determining that the first condition is satisfied based on the first information, determining the target gNB based on the measurement report of the UE and the SNPN list in the first information, and determining the target SNPN where the target gNB is located, and then performing S513. The specific process of this illustration is the same as the process of the embodiments described above, and not repeated herein.

In some other embodiments, performing the process on the UE based on the first information includes: in response to determining, based on the first information, that the second condition is satisfied, determining one or more candidate gNBs based on the measurement report of the UE; in the case that one or more candidate first-type access network device are included in the one or more candidate gNBs, selecting the target gNB from the one or more candidate first-type access network device, wherein the first-type access network device is a gNB of the non-shared network. Then, S514 is performed. The specific process of this illustration is the same as the process of the embodiments described above, and not repeated herein.

In the case that the second condition is determined to be satisfied based on the first information and the one or more candidate gNBs do not include the candidate first-type access network device, the source gNB releases the RRC connection to the UE or transmits the second information to the source AMF, wherein the second information is configured for the source AMF to release the NAS connection to the UE. In this case, the process is ended, that is, the subsequent processes are not performed. A new gNB is selected and the process S501 is performed again.

In S513, the source gNB transmits the handover required message to the source AMF.

In some embodiments, in the case that the target gNB is determined and the target SNPN where the target gNB is located is determined in S512, in S513, the source gNB transmits the first handover required message to the source AMF. For example, the first handover required message carries at least one of: a target ID, a source to target transparent container, an SM N2 information list, a PDU session ID, or an intra-system handover indication. The target ID contains the target SNPN ID (or the identifier-related information of the target SNPN) and the identifier of the target gNB. The identifier-related information of the target SNPN contains one of the target NID or the identifier of the target PLMN and the target NID.

In some other embodiments, in the case that the target gNB is determined in the S512, in S513, the source gNB transmits the second handover required message to the source AMF, wherein the target ID in the second handover required message contains the identifier of the target gNB. It is understandable that the second handover required message has the same content as the embodiments described above except for the target ID.

In S514, the source AMF transmits the Namf_Communication_CreateUEContext request to the target AMF.

In S515, the target AMF transmits the handover request to the target gNB.

In S516, the target gNB transmits the handover request acknowledgement to the target AMF.

In some embodiments, in the case that the target gNB is determined and the target SNPN where the target gNB is located is determined in S512, in S516, the target gNB transmits the first handover request acknowledgement to the target AMF. The first handover request acknowledgement carries a target to source container. The target to source container carries the target SNPN ID. In the case that the source SNPN ID (that is, the identifier of the first SNPN described above) is the same as the PLMN ID in the target SNPN ID, the target to source container only carries the NID. In addition, the target to source container further carries the identifier of the target gNB.

In some other embodiments, in the case that the target gNB is determined in S512, in S516, the target gNB transmits the second handover request acknowledgement to the target AMF. The target to source container of the second handover request acknowledgement carries the identifier of the target gNB.

In S517, the target AMF transmits the Namf_Communication_CreateUEContext response to the source AMF.

In S518, the source AMF transmits the handover command to the source gNB.

In some embodiments, in the case that the target gNB is determined and the target SNPN where the target gNB is located is determined in S512, in S518, the source AMF transmits the first handover command to the source gNB. The first handover command carries the identifier-related information of the target SNPN and the identifier (ID) of the target gNB. The identifier-related information of the target SNPN is the same as the embodiments described above, and not repeated herein.

In some other embodiments, in the case that the target gNB is determined in S512, in S518, the source AMF transmits the second handover command to the source gNB, wherein the second handover command carries the identifier of the target gNB.

In S519, the source gNB transmits the handover command to the UE.

The handover command is the same as the handover command described in S518, which is not repeated herein.

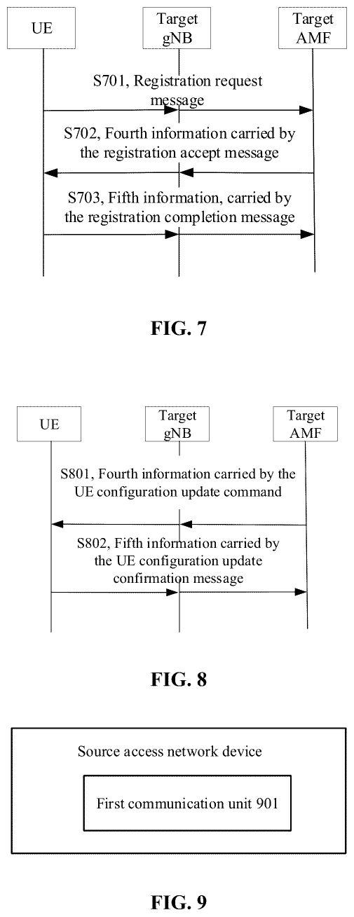

Taking the target access network device being the target gNB, the target core network device being the target AMF, and the terminal device being the UE as an example, an illustration of the methods for communication provided by the above embodiments is illustrated in conjunction with FIG. 7.

In S701, the UE transmits the registration request message to the target AMF over the target gNB.

This process is performed in the handover execution stage upon the completion of S519. The registration request message carries the 5G-GUTI, UE security capability, the requested NSSAI and other parameters.

In S702, the UE receives the fourth information from the target AMF over the target gNB, wherein the fourth information is carried by the registration accept message.

The registration acceptance message carries the new 5G-GUTI and the identifier-related information of the registered SNPN, wherein the identifier-related information of the registered SNPN includes one of the registered NID, or the identifier of the registered PLMN and the registered NID.

In S703, the UE transmits the fifth information to the target AMF over the target gNB, wherein the fifth information is carried by the registration completion message.

The registration completion message is further configured to confirm that the new 5G-GUTI takes effect. That is, the fifth information contains two information units, or two IEs, which are referred to as the first IE and the second IE respectively, wherein the first IE is configured to carry the confirmation message that the new 5G-GUTI takes effect, and the second IE is configured to carry the registered SNPN confirmation message.

The fifth information contains the registered SNPN confirmation message, and the fifth information is configured to instruct the target core network device to perform the authentication process on the terminal device based on the identifier of the registered SNPN. In some embodiments, the target core network device and the terminal device perform the authentication process by taking the identifier of the registered SNPN as the service network name. The specific authentication process is not described herein. In the case that the fifth information does not contain the registered SNPN confirmation message, the target core network device determines that the terminal device cannot parse the identifier of the registered SNPN. In this case, the NAS connection to the terminal device is released directly, or the terminal device is registered directly.

Taking the target access network device being the target gNB, the target core network device being the target AMF, and the terminal device being the UE as an example, an illustration of the methods for communication provided by the above embodiments is illustrated in conjunction with FIG. 8.

In S801, the UE receives the fourth information from the target AMF over the target gNB, wherein the fourth information is carried by the UE configuration update command.

This process is performed upon the completion of S519 and the handover process. For example, the UE configuration update command carries the new 5G-GUTI and the identifier-related information of the registered SNPN.

In S802, the UE transmits the fifth information to the target AMF over the target gNB, wherein the fifth information is carried by the UE configuration update confirmation message. For example, the UE configuration update confirmation message at least includes the third IE, wherein the third IE is configured to carry the registered SNPN confirmation message.

FIG. 9 is a first schematic block diagram of a source access network device according to some embodiments of the present disclosure. The source access network device includes a first communication unit 901.

The first communication unit 901 is configured to receive first information from a source core network device; wherein

the first information is configured to determine whether to perform a handover process on a terminal device, and the first information is related to capability information of the terminal device, the capability information of the terminal device indicating whether the terminal device supports a handover to a different SNPN.

The first information contains at least one of the capability information of the terminal device or a SNPN list.

The SNPN list contains an identifier of a second SNPN, wherein the second SNPN is an SNPN equivalent to a first SNPN, the first SNPN being an SNPN selected by the terminal device, and the identifier of the second SNPN being different from an identifier of the first SNPN.

As shown in FIG. 10, the source access network device further includes a first processing unit 902.

The first processing unit 902 is configured to perform the handover process on the terminal device based on a measurement report of the terminal device and the first information in response to determining, based on the first information, that a first condition is satisfied.

The first condition includes one of: the first information containing the SNPN list and not containing the capability information of the terminal device; or the first information containing the SNPN list and the capability information of the terminal device, and the capability information of the terminal device indicating that the terminal device supports the handover to the different SNPN.

In the case that the capability information of the terminal device indicates that the terminal device supports the handover to the different SNPN, the first information contains the SNPN list.

The first processing unit 902 is configured to determine a target access network device based on the measurement report of the terminal device and the SNPN list in the first information; and determine a target SNPN where the target access network device is located, wherein the target SNPN is contained in the second SNPN of the SNPN list; and

the first communication unit 901 is configured to transmit a first handover command to the terminal device, wherein the first handover command contains identifier-related information of the target SNPN and an identifier of the target access network device.

The identifier-related information of the target SNPN contains one of: a target NID; or an identifier of a target PLMN and a target NID.

The first processing unit 902 is configured to determine one or more candidate access network devices based on the measurement report of the terminal device; and determine the target access network device from the one or more candidate access network devices based on an identifier of an SNPN supported by the one or more candidate access network devices and an identifier of a second SNPN contained in the SNPN list in the first information.

The first processing unit 902 is configured to determine the one or more candidate access network devices based on the measurement report of the terminal device in response to determining, based on the first information, that a second condition is satisfied; and determine whether to perform the handover process on the terminal device based on the one or more candidate access network devices.

The second condition includes: the first information containing the SNPN list and the capability information of the terminal device, and the capability information of the terminal device indicating that the terminal device does not support the handover to the different SNPN.

The first processing unit 902 is configured to select the target access network device from one or more candidate first-type access network devices in the case that the one or more candidate access network devices include the one or more candidate first-type access network devices, wherein the first-type access network device is an access network device of a non-shared network; and

the first communication unit 901 is configured to transmit a second handover command to the terminal device, wherein the second handover command contains an identifier of the target access network device.

The first processing unit 902 is configured to release an RRC connection to the terminal device in the case that the one or more candidate access network devices do not include the candidate first-type access network device.

The first processing unit 902 is configured to transmit second information to the source core network device over the first communication unit 901 in the case that the one or more candidate access network devices do not include the candidate first-type access network device, wherein the second information is configured for the source core network device to release an NAS connection to the terminal device.

The first communication unit 901 is configured to transmit third information from the terminal device to the source core network device, wherein the third information contains the capability information of the terminal device.

The source core network device is a source AMF entity.

The source access network device according to the embodiments of the present disclosure is capable of realizing the corresponding functions of the source access network device in the embodiments described above. The corresponding processes, functions, realization methods, and beneficial effects of each module (sub-module, unit, or assembly) of the source access network device are referred to the method embodiments described above, and not be repeated herein. It should be noted that the functions described for each module (sub-module, unit, or assembly) of the source access network device according to the embodiments of the disclosure may be realized by different modules (sub-modules, units, or assemblies), or may be realized by the same module (sub-module, unit, or assembly).

FIG. 11 is a schematic block diagram of a source core network device according to some embodiments of the present disclosure. The source core network device includes a second communication unit 1101.

The second communication unit 1101 is configured to receive third information from a terminal device over a source access network device, wherein the third information contains the capability information of the terminal device, the capability information of the terminal device indicating whether the terminal device supports a handover to a different SNPN; and transmit first information to the source access network device, wherein the first information is configured for the source access network device to determine whether to perform a handover process on the terminal device, and the first information is related to the capability information of the terminal device.

The first information contains at least one of the capability information of the terminal device or a SNPN list.

In the case that the capability information of the terminal device indicates that the terminal device supports the handover to the different SNPN, the first information contains the SNPN list.

The SNPN list contains an identifier of a second SNPN, wherein the second SNPN is an SNPN equivalent to a first SNPN, the first SNPN being an SNPN selected by the terminal device, and the identifier of the second SNPN being different from an identifier of the first SNPN.

The second communication unit 1101 is configured to receive second information from the source access network device, wherein the second information is configured for the source core network device to release a NAS connection to the terminal device.

The source core network device is a source AMF entity.

It is understandable that the source core network device includes a second processing unit in addition to the second communication unit, wherein the second process unit performs the process in the methods for communication described above, such as generating first information, which is not described herein.

The source core network device according to the embodiments of the present disclosure is capable of realizing the corresponding functions of the source core network device in the embodiments described above. The corresponding processes, functions, realization methods, and beneficial effects of each module (sub-module, unit, or assembly) of the source core network device are referred to the method embodiments described above, and not be repeated herein. It should be noted that the functions described for each module (sub-module, unit, or assembly) of the source core network device according to the embodiments of the disclosure may be realized by different modules (sub-modules, units, or assemblies), or may be realized by the same module (sub-module, unit, or assembly).

FIG. 12 is a first schematic block diagram of a terminal device according to some embodiments of the present disclosure. The terminal device includes a third communication unit 1201.

The third communication unit 1201 is configured to transmit third information to a source core network device over a source access network device, wherein the third information contains capability information of the terminal device, the capability information of the terminal device indicating whether the terminal device supports a handover to a different SNPN, wherein the third information is configured for the source core network device to transmit first information to the source access network device, the first information is configured for the source access network device determining whether to perform a handover process on the terminal device, the first information being related to the capability information of the terminal device.

The third communication unit 1201 is configured to receive a first handover command from the source access network device, wherein the first handover command contains identifier-related information of a target SNPN and an identifier of a target access network device.

The identifier-related information of the target SNPN includes one of: a target NID; or identifier of a target PLMN and a target NID.

The third communication unit 1201 is configured to receive a second handover command from the source access network device, wherein the second handover command contains an identifier of a target access network device, the target access network device being a first-type access network device, the first-type access network device being an access network device of a non-shared network.

As shown in FIG. 13, the terminal device further includes a third processing unit 1202, wherein the third processing unit 1202 is configured to determine an SNPN supported by the target access network device as the identifier of the target SNPN; and the third communication unit 1201 is configured to receive broadcast information from the target access network device, wherein the broadcast information contains the identifier of the SNPN supported by the target access network device.

The third communication unit 1201 is configured to receive fourth information from a target core network device over the target access network device, wherein the fourth information contains identifier-related information of a registered SNPN, the identifier-related information of the registered SNPN including one of: a registered NID; an identifier of a registered PLMN and a registered NID.

The third communication unit 1201 is configured to transmit fifth information to the target core network device over the target access network device, wherein the fifth information is configured for the target core network device to determine whether to perform an authentication process on the terminal device.

In the case that the fifth information contains a registered SNPN confirmation message, the fifth information is configured for the target core network device to perform the authentication process on the terminal device based on the identifier of the registered SNPN.

In the case that the fifth information does not contain the registered SNPN confirmation message, the fifth information is configured for the target core network device to determine whether to release the NAS connection to the terminal device or to register the terminal device.

In the case that the fifth information does not contain the registered SNPN confirmation message, the fifth information is configured for the target core network device to determine to release the NAS connection to the terminal device or to register the terminal device in the case that the target access network device is not the first-type access network device.

The fifth information is carried by a registration completion message or a UE configuration update confirmation message.

The target core network device is a target AMF entity.

The source core network device is a source AMF entity.

The terminal device according to the embodiments of the present disclosure is capable of realizing the corresponding functions of the terminal device in the embodiments described above. The corresponding processes, functions, realization methods, and beneficial effects of each module (sub-module, unit, or assembly) of the terminal device are referred to the method embodiments described above, and not be repeated herein. It should be noted that the functions described for each module (sub-module, unit, or assembly) of the terminal device according to the embodiments of the disclosure may be realized by different modules (sub-modules, units, or assemblies), or may be realized by the same module (sub-module, unit, or assembly).

FIG. 14 is a schematic block diagram of a communication device 1400 according to some embodiments of the present disclosure. The communication device 1400 includes a processor 1410, wherein the processor 1410, when loading and running at least one computer program from a memory, causes the communication device 1400 equipped with the processor 1410 to perform the methods as described the embodiments of the present disclosure.

In some embodiments, the communication device 1400 further includes a memory 1420, wherein the processor 1410, when loading and running at least one computer program from the memory 1420, causes the communication device 1400 equipped with the processor 1410 to perform the methods as described in the embodiments of the present disclosure.

The memory 1420 is a separate component from the processor 1410, or the memory 1420 is integrated in the processor 1410.

In some embodiments, the communication device 1400 further includes a transceiver 1430, wherein the processor 1410 controls the transceiver 1430 to communicate with other devices. For example, the processor 1410 controls the transceiver 1430 to transmit information or data to other devices, or to receive information or data from other devices.

The transceiver 1430 includes a transmitter and a receiver. The transceiver 1430 further includes one or more antennas.

In some embodiments, the communication device 1400 is the source access network device according to the embodiments of the present disclosure, and the communication device 1400 achieves the corresponding processes achieved by the source access network device in the various methods according to the embodiments of the present disclosure, which are not repeated herein for brevity.

In some embodiments, the communication device 1400 is the source core network device according to the embodiments of the present disclosure, and the communication device 1400 achieves the corresponding processes achieved by the source core network device in the various methods according to the embodiments of the present disclosure, which are not repeated herein for brevity.

In some embodiments, the communication device 1400 is the terminal device according to the embodiments of the present disclosure, and the communication device 1400 achieves the corresponding processes achieved by the terminal device in the various methods according to the embodiments of the present disclosure, which are not repeated herein for brevity.

FIG. 15 is a schematic block diagram of a chip 1500 according to some embodiments of the present disclosure. The chip 1500 includes a processor 1510, wherein the processor 1510, when loading and running at least one computer program from a memory, is caused to perform the methods as described in the embodiments of the present disclosure.

In some embodiments, the chip 1500 further includes a memory 1520, wherein the processor 1510, when loading and running at least one computer program from the memory 1520, is caused to perform the method performed by the terminal device or the network device in the embodiments of the present disclosure.

The memory 1520 is a separate component from the processor 1510, or the memory 1520 is integrated in the processor 1510.

In some embodiments, the chip 1500 further includes an input interface 1530, wherein the processor 1510 controls the input interface 1530 to communicate with other devices or chips. For example, the processor 1510 controls the input interface 1530 to receive information or data from other devices or chips.

In some embodiments, the chip 1500 further includes an output interface 1540, wherein the processor 1510 controls the output interface 1540 to communicate with other devices or chips. For example, the processor 1510 controls the output interface 1540 to output information or data to other devices or chips.

In some embodiments, the chip is applicable to the source access network device according to the embodiments of the present disclosure, and the chip achieves the corresponding processes achieved by the source access network device in the various methods according to the embodiments of the present disclosure, which are not repeated herein for brevity.

In some embodiments, the chip is applicable to the source core network device according to the embodiments of the present disclosure, and the chip achieves the corresponding processes achieved by the source core network device in the various methods according to the embodiments of the present disclosure, which are not repeated herein for brevity.

In some embodiments, the chip is applicable to the terminal device according to the embodiments of the present disclosure, and the chip achieves the corresponding processes achieved by the terminal device in the various methods according to the embodiments of the present disclosure, which are not repeated herein for brevity.

The chips applied to the network device and the terminal device are the same chip or different chips.

It is understandable that the chip in the embodiments of the present disclosure is also referred to as a system-level chip, a systematic chip, a chip system, or a system-on-chip.

The processor mentioned above is a general-purpose processor, a digital signal processor (DSP), a field-programmable gate array (FPGA), an application-specific integrated circuit (ASIC), or other programmable logic device, a transistor logic device, or a discrete hardware component. The general-purpose processor is a microprocessor or the processor is any conventional processor.

The memory mentioned above is a volatile memory or a non-transitory memory, or the memory includes both the transitory memory and the non-transitory memory. The non-transitory memory is a read-only memory (ROM), a programmable ROM (PROM), an erasable PROM (EPROM), an electrically EPROM (EEPROM), or a flash memory. The transitory memory is a random access memory (RAM).

It is understandable that the memory described above is exemplary but not limited. For example, the memory according to the embodiments of the present disclosure is a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), or a direct rambus RAM (DR RAM). That is, the memory in the system and method described herein is intended to include, but is not limited to, these and any other suitable types of memory.

FIG. 16 is a schematic block diagram of a communication system 1600 according to some embodiments of the present disclosure. The communication system 1600 includes a terminal device 1610 and a network device 1620.

The terminal device 1610 is configured to perform the corresponding function achieved by the terminal device in the methods described above, and the network device 1620 is configured to perform the corresponding function achieved by the network device (source access network device, and/or source core network device) in the methods described above, which are not described herein for brevity.

The embodiments described above are realized in whole or in part by software, hardware, firm ware or any combination thereof. In the case that the embodiments are performed by software, the embodiments are performed in the form of a computer program product in whole or in part. The computer program product includes one or more computer instructions. The one or more computer program instructions, when loaded and run by the computer, wholly or partially generate the flow or function according to the embodiment of the disclosure. The computer is a general purpose computer, a dedicated computer, a computer network, or other programmable device. The one or more computer instructions are stored in a computer-readable storage medium, or transmitted from one computer-readable storage medium to another computer-readable storage medium. For example, the one or more computer instructions are transmitted from a website site, a computer, a server or a data center over a cable (such as a coaxial cable, an optical fiber, a digital subscriber line (DSL)) or wireless (such as infrared, wireless, or microwave) to another website site, computer, server or data center. The computer-readable storage medium is any available medium that is accessed by a computer or a data storage device such as a server including one or more available medium integration or a data center. The available medium is a magnetic medium (for example, a floppy disk, a hard disk, and a magnetic tape), an optical medium (for example, a DVD), or a semiconductor medium (for example, a solid state disk (SSD)).

It is understandable that, in various embodiments of the present disclosure, the serial number of each of the above processes does not imply the order of execution, and the order of execution of each of the processes should be determined by its function and inherent logic, without constituting any limitation of the implementation process of the embodiments of the present disclosure.

It is clear to those of ordinary skilled that, for the convenience and brevity of the description, the specific work processes of the systems, apparatuses, and units described above are referred to the corresponding processes in the method embodiments, and are not repeated herein.

Described above are merely specific implementations of the present disclosure, but the protection scope of the present disclosure is not limited thereto. Those skilled in the art who are familiar with the technical field would readily think of variations or substitutions within the scope of the technology disclosed in the present disclosure, which shall be covered by the protection scope of the present disclosure. Therefore, the protection scope of this application shall be subject to the protection scope of the claims.

What is claimed is:

1. A communication method, applicable to a source access network device, the method comprising:
receiving first information from a source core network device, wherein the first information is configured for the source access network device to determine whether to perform a handover process on a terminal device, and the first information is related to capability information of the terminal device, wherein the capability information of the terminal device indicates whether the terminal device supports a handover to a different stand-alone non-public network (SNPN).

2. The method according to claim 1, wherein the first information comprises at least one of the capability information of the terminal device or an SNPN list.

3. The method according to claim 2, wherein the SNPN list comprises an identifier of a second SNPN, the second SNPN being an SNPN equivalent to a first SNPN, wherein the first SNPN is an SNPN selected by the terminal device, and the identifier of the second SNPN is different from an identifier of the first SNPN.

4. The method according to claim 3, further comprising:
performing the handover process on the terminal device based on a measurement report of the terminal device and the first information in response to determining, based on the first information, that a first condition is satisfied.

5. The method according to claim 4, wherein the first condition comprises one of following items:
the first information contains the SNPN list; or
the first information contains the SNPN list and the capability information of the terminal device, and the capability information of the terminal device indicates that the terminal device supports the handover to the different SNPN.

6. The method according to claim 5, wherein the first information comprises the SNPN list in a case that the capability information of the terminal device indicates that the terminal device supports the handover to the different SNPN.

7. The method according to claim 5, wherein performing the handover process on the terminal device based on the measurement report of the terminal device and the first information comprises:
determining a target access network device based on the measurement report of the terminal device and the SNPN list in the first information;
determining a target SNPN where the target access network device belongs to, wherein the target SNPN is contained in the second SNPN of the SNPN list; and
transmitting a first handover command to the terminal device, wherein the first handover command contains identifier-related information of the target SNPN and an identifier of the target access network device.

8. The method according to claim 7, wherein the identifier-related information of the target SNPN comprises one of:
a target network identifier (NID); or
a target NID and an identifier of a target public land mobile network (PLMN).

9. The method according to claim 7, wherein determining the target access network device based on the measurement report of the terminal device and the SNPN list in the first information comprises:
determining one or more candidate access network devices based on the measurement report of the terminal device; and
determining the target access network device from the one or more candidate access network devices based on an identifier of an SNPN supported by the one or more candidate access network devices and the identifier of the second SNPN contained in the SNPN list in the first information.

10. The method according to claim 2, further comprising:
determining one or more candidate access network devices based on a measurement report of the terminal device in response to determining, based on the first information, that a second condition is satisfied; and
determining, based on the one or more candidate access network devices, whether to perform the handover process on the terminal device.

11. The method according to claim 10, wherein the second condition comprises following item:
the first information contains the SNPN list and the capability information of the terminal device, and the capability information of the terminal device indicates that the terminal device does not support the handover to the different SNPN.

12. The method according to claim 10, wherein determining, based on the one or more candidate access network devices, whether to perform the handover process on the terminal device comprises:
selecting a target access network device from one or more candidate first-type access network devices in a case that the one or more candidate access network devices contain the one or more candidate first-type access network devices, wherein each of the first-type access network devices is an access network device of a non-shared network; and
transmitting a second handover command to the terminal device, wherein the second handover command contains an identifier of the target access network device.

13. A source access network device, comprising:
a processor; and
a memory storing at least one computer program, which, when executed by the processor, causes the source access network device to:
receive first information from a source core network device, wherein the first information is configured for the source access network device to determine whether to perform a handover process on a terminal device, and the first information is related to capability information of the terminal device, wherein the capability information of the terminal device indicates whether the terminal device supports a handover to a different stand-alone non-public network (SNPN).

14. The source access network device according to claim 13, wherein the first information comprises at least one of the capability information of the terminal device or an SNPN list.

15. A source core network device, comprising:
a processor; and
a memory storing at least one computer program, which, when executed by the processor, causes the source core network device to:
receive third information from a terminal device, wherein the third information contains capability information of the terminal device, the capability information of the terminal device indicating whether the terminal device supports a handover to a different stand-alone non-public network (SNPN); and
transmit first information to a source access network device, wherein the first information is configured for the source access network device to determine whether to perform a handover process on the terminal device, the first information being related to the capability information of the terminal device.

16. The source core network device according to claim 15, wherein the first information comprises at least one of the capability information of the terminal device or an SNPN list.

17. The source core network device according to claim 16, wherein the first information comprises the SNPN list in a case that the capability information of the terminal device indicates that the terminal device supports the handover to the different SNPN.

18. The source core network device according to claim 16, wherein the SNPN list comprises an identifier of a second SNPN, the second SNPN being an SNPN equivalent to a first SNPN, wherein the first SNPN is an SNPN selected by the terminal device, and the identifier of the second SNPN is different from an identifier of the first SNPN.

19. The source core network device according to claim 15, wherein the at least one computer program, when executed by the processor, further causes the source core network device to:
receive second information from the source access network device, wherein the second information is configured for the source core network device to release a non-access stratum (NAS) connection to the terminal device.

20. The source core network device according to claim 15, wherein the source core network device is a source access and mobility management function (AMF) entity.
